(19) United States
(12) Patent Application Publication
(10) Pub. No.: US 2014/0350981 A1
(43) Pub. Date: Nov. 27, 2014

(54) SERVICE PROVIDER ALLOCATION SYSTEM AND ALLOCATION MANAGEMENT DEVICE

(71) Applicant: Hitachi, Ltd., Tokyo (JP)

(72) Inventors: Tadaoki UESUGI, Tokyo (JP); Satoshi OSAWA, Tokyo (JP); Yukinori TERAHAMA, Tokyo (JP)

(73) Assignee: HITACHI, LTD., Tokyo (JP)

(21) Appl. No.: 14/287,703

(22) Filed: May 27, 2014

(30) Foreign Application Priority Data
May 27, 2013 (JP) 2013-110485

(51) Int. Cl. G06Q 10/06

(52) U.S. Cl. CPC G06Q 10/063112
USPC 705/7.14

(57) ABSTRACT

In the present invention, the allocation process of a service provider to a target case, which is performed for each case unit, is performed by calculating the grace period for extending the allocation process, and controlling the allocation to cases, including the target case, according to the state relating to allocation of the other cases while reflecting the service request level including the compatibility between the other service providers and the user in the grace period.

### CLAIM OF PRIORITY

The present application claims priority from Japanese application serial no. JP2013-110485, filed on May 27, 2013, the content of which is hereby incorporated by reference into this application.

### BACKGROUND

The present invention relates to a technology for the allocation of an appropriate service provider in the provision of various services from an organization to a user (for example, from a company to a consumer).

Currently, when companies or other organizations provide their services to users, a service provider who is the person in charge is allocated to each user. For example, in an insurance company, a service provider such as a salesperson is allocated to a subscriber (or prospective customer) to provide consultation on payment, update, subscription, and the like. There are many service providers and their abilities, or in particular, specialties vary as well. Further, there are many users with different needs, and in addition, the needs often vary over time. In this case, the problem is that which of the service providers should be allocated.

By way of background of the art, there is U.S. Pat. No. 8,126,135. In this publication, it is described that: “At least one service providing route is established for each service resource. A service router can receive multiple service provision requests through multiple communication channels. Each service provision request is analyzed based on the feature value of the service provision request. The feature value of the service provision request is compared with the routing rule. Each service provision request is automatically transferred to the selected service resource, at least partially based on the comparison result. The value of the routing rule is dynamically changed based on feedback.”

### SUMMARY

In U.S. Pat. No. 8,126,135, the ability score of each service provider (service resource) is calculated, and each time a service provision request arrives, the service provider with the highest ability score is allocated to the particular provision request. However, there is a problem that if no service provider with high ability score is left unallocated, it is difficult to allocate a person with high ability upon request for an important service provision request (in the case where the customer is an important one, or other cases).

In order to solve the above problem, according to the present invention, the allocation process of a service provider to a target case, which is performed for each case unit, is performed by calculating the grace period for extending the allocation process, and by controlling the allocation to cases including the target case, according to the state relating to the other case allocation while reflecting the service request level including the compatibility between the other service providers and the user in the particular grace period.

Further, in the control of the allocation, the allocation process is performed (a) by placing the allocation of the target case in a suspended state when a case with a higher service request level than the target case continues in the grace period, (b) by performing the allocation process, including the target case, when it is detected that the case with a higher service request level than the target case does not continue in the grace period, and (c) when any of the cases reaches the allocation due time.

As a more specific configuration of the present invention, for example, the configuration described in the claims is adopted. The present application includes multiple sections that solve the above problem. To cite an example, there is “a system service provider allocation system including:
a service provision request receiving device for receiving a service provision request from a customer;
a service provider management device capable of allowing storage, editing, and reference of the personal information of a service provider;
a customer management device capable of allowing storage, editing, and reference of the personal information of a customer;
an allocation management device capable of allowing storage, editing, and reference of the request content and progress of multiple service provision requests; and
an allocation execution device for allocating a service provider to a service provision request,
wherein the service provision request receiving device stores the request content and progress of the service provision request group, into the allocation management device,
the allocation execution device refers to the personal information of the service provider of the service provider management device, the personal information of the customer of the customer management device, and the request content and progress of the service provision request in the allocation management device, and
the allocation execution device allocates multiple service providers to a subset of the service provision request group as a whole”.

According to the present invention, it is possible to allocate a service provider to a user who receives service provision more appropriately.

### BRIEF DESCRIPTION OF THE DRAWINGS

FIG. 1 shows an example of the concept of batch allocation according to an embodiment of the present invention;

FIG. 2 shows an example of the effect of an allocation system according to an embodiment of the present invention;

FIG. 3 is a schematic diagram illustrating the terms, such as allocation grace period and non-allocation period, used in an embodiment of the present invention;

FIG. 4 shows an example of the batch allocation according to an embodiment of the present invention;

FIG. 5 is a flow chart of the allocation method according to an embodiment of the present embodiment;

FIG. 6 is a block diagram of the allocation system according to an embodiment of the present invention (part 1);

FIG. 7 shows an example of tables stored in an allocation management device according to an embodiment of the present invention;

FIG. 8 shows an example of tables stored in a customer management device according to an embodiment of the present invention;

FIG. 9 shows an example of a table stored in a service provider management device according to an embodiment of the present invention;

FIG. 10 shows the functional configuration of the allocation management device according to an embodiment of the present invention; and

FIG. 11 is a block diagram of the allocation system according to an embodiment of the present invention (part 2).

### DETAILED DESCRIPTION

Hereinafter, an embodiment of the present invention will be described with reference to the accompanying drawings. In the embodiment, the sales activities in the life insurance sector will be described as an example. However, the present invention is also applicable to other services.

Many of the sales activities in the life insurance sector are “hard sell”. In other words, this is a method that sales staff or sales representatives, called life-insurance ladies, approach customers to make insurance sales, instead of selling insurance products after a customer refers to the life insurance company. The present embodiment assumes a scenario that the life insurance company detects the life events of the customer to make a “business chance”. For example, it is assumed that the life insurance company has information on the family structure of the customer, and understands that the child of the customer will enter elementary school next April. This is a “business chance” from the point of view that it can lead to an educational insurance proposal. As another example, it is assumed that the life insurance company can detect that the salary of the customer would be reduced from next April due to the poor business performance of the company at which the customer works. The life insurance company assumes a risk that the customer may cancel the insurance to move to an inexpensive insurance company soon. Thus, the life insurance company proposes the customer to review the insurance ahead of this risk, thereby allowing the customer to continue to use the company's own service. This is also a “business chance”, although not having a positive meaning.

As described above, when the salesperson launches sales activities to the customer, the life insurance company understands the situation of the customer in advance. In the above example, “the child will enter elementary school next April” and “there is high possibility that the salary of the customer would be reduced from next April” are the situation of the customer. When the need to launch sales activities occurs due to the understanding of such a situation, each of the sales activities will be hereinafter referred to as a “case”. In the life insurance company, a case occurs from time to time and, in general, multiple cases exist in parallel. The problem for the life insurance company is to who is allocated to each case from a limited number of salespersons.

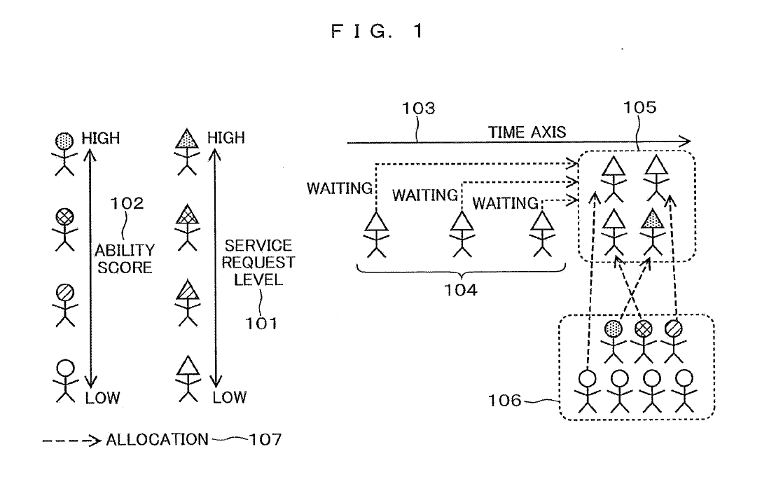

FIG. 1 is a view showing the concept of allocation of sales staff according to the present embodiment. In FIG. 1, reference numeral 101 schematically shows the customer service request level. Reference numeral 102 denotes the ability score of each of the sales staff. A high service request level means that the degree of difficulty in service provision is high, or the customer is an important one, or both of them. Reference numeral 103 denotes the time axis. Reference numeral 104 denotes the state in which three cases occur at different times. Reference numeral 105 denotes multiple cases which are pooled together. Reference numeral 106 denotes unallocated salespersons who are pooled together. Reference numeral 107 denotes the state in which the unallocated salespersons are allocated to each case.

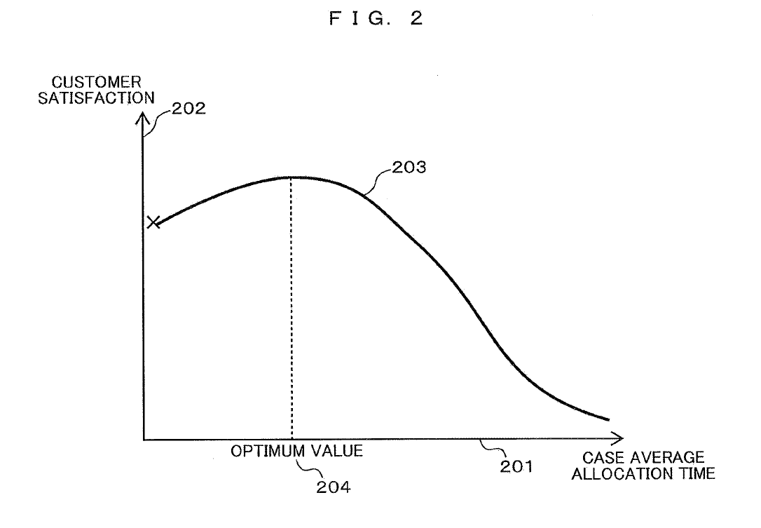

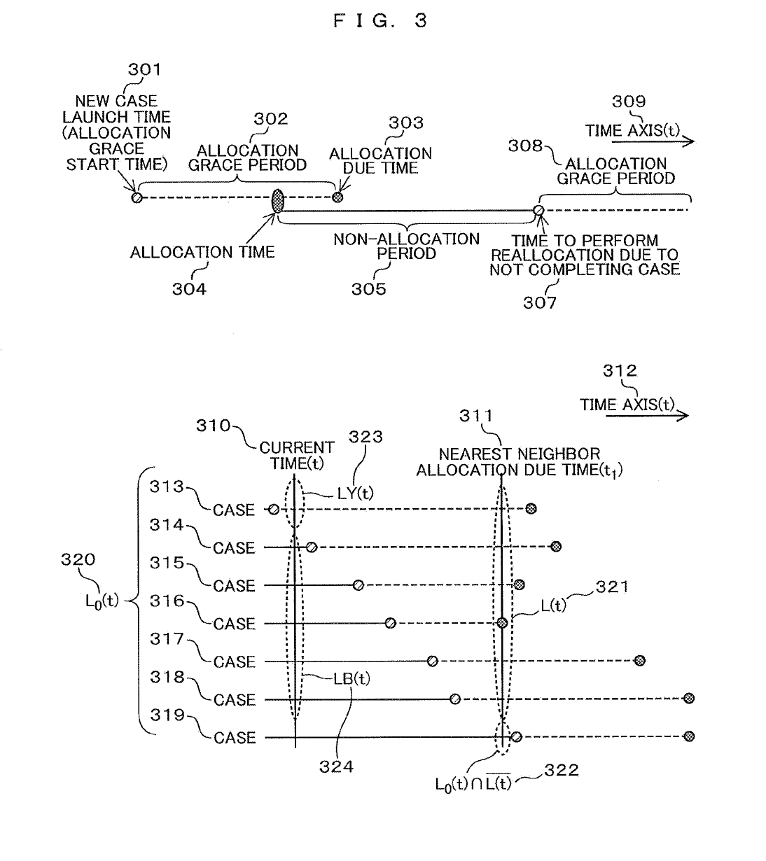

FIG. 2 schematically shows the effect obtained by performing the present embodiment. A horizontal axis 201 of the graph is the case average allocation time. In other words, the time from the occurrence of a case to the allocation of a salesperson is averaged over all cases. A vertical axis 202 corresponds to the total value for all customers with respect to the degree of satisfaction that the customer feels after the service is provided. The degree of satisfaction can be measured by a questionnaire to the customer, and the like. However, other measurement results may also be used. Reference numeral 203 denotes a curve example of the graph, and reference numeral 204 denotes the case average allocation time that gives the maximum value of the graph. The point where the case average allocation time is zero indicates the allocation method in the conventional technology. In other words, this is “real time allocation” for allocating a salesperson immediately after a case occurs. In the present embodiment, as shown in FIG. 1, a “batch allocation” is performed by pooling multiple cases and matching multiple cases to multiple salespersons at an “appropriate timing”, which will be described below, instead of immediately allocating a salesperson. By performing the batch allocation, a salesperson with a higher ability score can be allocated to a case with a higher service request level. Thus, it is possible to allocate the right person to the right place, and to reduce mismatching probability. In other words, this leads to increasing the degree of customer satisfaction. At the same time, the batch allocation has the side effects of keeping the customer waiting. However, many of the life-insurance sales activities are “hard sell”, in which an immediate response, such as attending to inquiries from customers and handling of complaints, is not required, so that there is a little more time for case allocation. In other words, until the case average allocation time reaches a certain value, the advantage of putting the right person to the right place by the batch allocation is greater than the disadvantage due to the allocation being extended, resulting in an increase in the degree of customer satisfaction. As a result, the graph showing the degree of customer satisfaction has the shape of 203. Reference numeral 204 denotes the optimal case average allocation time. The problem is how to decide the optimal value 204 (the “appropriate timing” described above). The algorithm for deciding the “appropriate timing” will be described with reference FIG. 3 and subsequent figures.

FIG. 3 defines the terms used in the present embodiment. In FIG. 3, reference numeral 301 denotes the time for dealing with a new case or allocation grace start time. Reference numeral 302 denotes the allocation grace period in which the sales staff allocation can be extended. Reference numeral 303 denotes the limited time to which the allocation of the salesperson remains in force, namely, the due time of the allocation by which one of the sales staff has to be allocated to a particular case. Reference numeral 304 denotes the allocation time in which the salesperson is actually allocated. Reference numeral 305 denotes the non-allocation period in which another salesperson may not be allocated because the particular salesperson is handling the case. Reference numeral 307 denotes the allocation grace start time in which reallocation to another salesperson is possible as the non-allocation period has elapsed. Reference numeral 308 denotes the allocation grace period in which the reallocation of the sale person can be extended. Reference numeral 309 denotes the time axis.

As shown in FIG. 3, the case lasts as long as a completion report is not submitted. When the case is not completed after a certain time has elapsed as in the non-allocation period 305, the case is likely to be taken over by the other salesperson (however, the case is not continued if the completion report of the case is submitted before reallocation is performed in the allocation grace period 308). If the salesperson, who took over the case, may not complete the case within the scheduled time, the particular case is taken over by the other salesperson. The particular case is finally closed at the time of the case completion report. In other words, the allocation grace period 302 and the non-allocation period 305 are alternately repeated unless the case completion report is submitted.

The lower part of FIG. 3 shows the state in which multiple cases exist in parallel. Reference numeral 310 denotes the current time and reference numeral 312 denotes the time axis. Reference numerals 313 to 319 correspond to each of the cases. Here, a case that reaches the allocation grace start time at least slightly earlier than the other cases is placed in the upper position. Of the allocation due times of the multiple cases, the earliest allocation due time from the current time 310 is referred to as the nearest neighbor allocation due time. Further, a set of cases is defined as follows. That is, the set of all cases is defined as L0(t). L0(t) is a function of time because the case addition to the set due to the occurrence of a new case, as well as the case deletion from the set due to the completion of a case occur from time to time. In the figure, a set 320 including cases 313 to 319 corresponds to L0(t). Next, the case in the phase of the allocation grace period at the nearest neighbor allocation due time 311, or the case that reaches the allocation due time is defined as L(t). L(t) is the subset of L0(t). In the figure, a set 321 including the cases 313 to 318 corresponds to L(t). The case 319 is included in L0(t) but not included in L(t) (a set 322). Next, of the cases included in L(t), the case in the phase of the allocation grace period at the current time (t) 310 is defined as LY(t). In the figure, only the case 313 belongs to LY(t). Next, of the cases included in L(t), the case in the phase of the non-allocation period at the current time (t) 310 is defined as LB(t). In the figure, the cases 314 to 318 belong to LB(t). Note that L(t) is the sum set of LY(t) and LB(t), and the product set of LY(t) and LB(t) is the empty set.

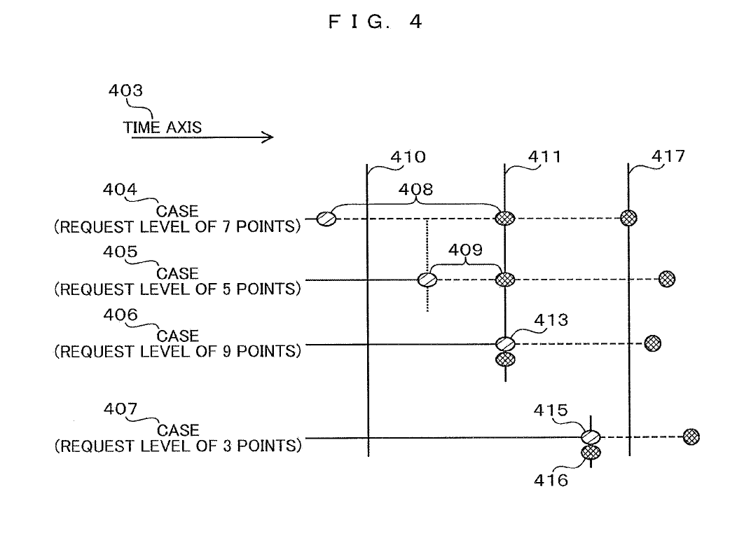

FIG. 4 shows a timing example for performing the batch allocation with four cases as a specific example. In FIG. 4, reference numeral 403 denotes the time axis, reference numeral 404 denotes the case in which the service request level is 7 points, reference numeral 405 denotes the case in which the service request level is 5 points, reference numeral 406 denotes the case in which the service request level is 9 points, and reference numeral 407 is the case where the service request level is 3 points. Reference numeral 408 denotes the “waiting” period from when the case 404 reaches the allocation grace start time to when the batch allocation is performed. Reference numeral 409 denotes the “waiting” period from when the case 405 reaches the allocation grace start time to when the batch allocation is performed. Reference numeral 410 denotes the current time (t), reference numeral 411 denotes the time when the batch allocation is performed to the cases 404, 405, and 406. Reference numeral 413 denotes the allocation grace start time of the case 406, reference numeral 415 denotes the allocation grace start time of the case 407, and 416 denotes the time when the allocation of the case 407 is performed. Reference numeral 417 denotes the nearest neighbor allocation due time. As shown in FIG. 4, the batch allocation is performed to the cases 404, 405, and 406, in which three salespersons are allocated simultaneously. On the other hand, the real time allocation is performed to the case 407, in which one salesperson is allocated. According to the case set definition described with reference to FIG. 3, when the current time is at the position of 410, the cases 404 to 407 belong to L0(t), the cases 404 to 407 belong to L(t), the case 404 belongs to LY(t), and the cases 405 to 407 belong to LB(t). Here, the term “simultaneous” means that the process unit can be allocated as a whole and may not be allocated exactly at the same time.

The following describes the concept of the sales staff allocation which is performed as described above. In FIG. 4, it is assumed that there are four unallocated salespersons A, B, C, D with different ability scores of 75, 50, 85, and 35 points, respectively. Of the four cases, the case 404 first reaches the allocation grace start time. At this time, the other three cases are in the phase of the non-allocation period. The case 404 has the second highest service request level of the four cases. The case with the highest service request level is the case 406. Thus, if the salesperson C with the highest ability score is allocated in real-time to the case 404 at the point of the allocation grace start time of the case 404, there is high possibility that the salesperson C will not be ensured when the case 406 reaches the allocation grace start time. Then, the next idea is that the salesperson A with the second highest ability score is allocated in real-time to the case 404. However, if the case 406 is completed before reaching the allocation grace start time, the case 404 can have the salesperson C with the highest ability score. The reason is that the case with the highest service request level at the point of the completion of the case 406 is the case 404 (however, unless a new case with a high service request level occurs halfway through).

Given this perspective, it is rational to monitor whether the case 406 is not completed, without allocating any salesperson to the case 404 as long as it does not reach the allocation due time. The monitoring period corresponds to the period 408. The same concept can be applied to the case 405. The service request level of the case 405 is the third highest of the four cases. However, if there is a completion report of the case 406, it is possible to have the salesperson A with the second highest ability score. Further, if the case 404 is also completed, it is possible to have the salesperson C with the highest ability score. Thus, it is rational to monitor whether the case 406 or 404 is not completed, without allocating any salesperson as long as the particular case does not reach the allocation due time. The monitoring period corresponds to the period 409. The case 404 continues to be monitored during the period 408 and the case 405 continues to be monitored during the period 409. As a result, the case 406 reaches the allocation grace start time 413. At this time, the case 406 is the case with the highest service request level, so that it is possible to have the salesperson C with the highest ability score. Further, the case 407 does not reach the allocation grace start time at this time. However, the service request level of the case 407 is the lowest of the other cases, so that the allocation result of the salesperson to the cases 404 and 405 is not affected by the case 407. Thus, the case 404 with the second highest service request level can have the salesperson A with the second highest ability score. The case 405 with the third highest service request level can have the salesperson B with the third highest ability score. In other words, the batch allocation is performed at the time 411 to allocate the salespersons A, B, C to the cases 404, 405, and 406, respectively. At the time when the case 407 finally reaches the allocation grace start time 415, there is no other case present (unless a new case occurs halfway through), so that the real time allocation is performed. At this time, only the salesperson D is unallocated. Thus, the salesperson D is allocated to the case 407.

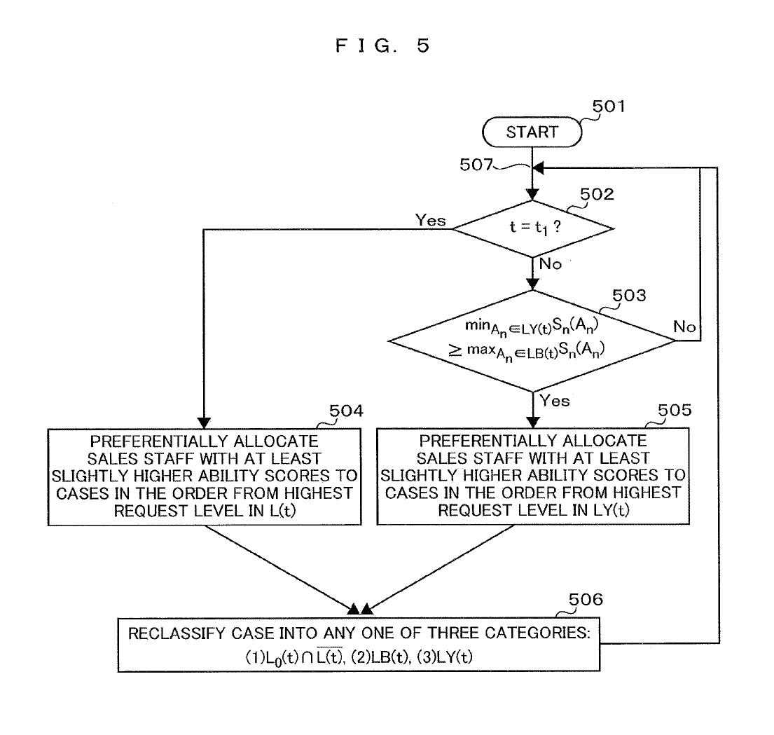

FIG. 5 generalizes the concept of FIG. 4 by a flow chart. Reference numeral 501 denotes the start node showing that a case occurs. Reference numeral 502 denotes the conditional branch to determine whether the current time (t) is equal to the nearest neighbor allocation due time (t1). When the result of the conditional branch 502 is YES, then the flow reaches a process 504. In the process 504, the batch allocation is performed to all the cases belonging to L(t). In other words, a salesperson with at least a slightly higher ability score (with a relatively high ability score of the unallocated ones) is allocated to a case with at least a slightly higher service request level. When the allocation is performed, all the cases belonging to L(t) move to the non-allocation period. The nearest neighbor allocation due time is also reset to a more future value. Thus, the set to which each case belongs varies, so that the elements of L0(t), L(t), LY(t), and LB(t) are redefined (process 506), and the flow chart returns to the monitoring position 507. On the other hand, if the result of the conditional branch 502 is NO, the flow chart moves to a conditional branch 503. The conditional branch 503 determines whether the minimum value of the service request level (Sn (An)) within LY(t) is greater than the maximum value of the service request level (Sn (An)) within LB(t).

In the example of FIG. 3, it is determined whether the service request level of the case 313 is greater than the maximum value of the service request level of the cases 314 to 318. In the example of FIG. 4, when the current time (t) is at the position of 410, the service request level (7 points) of the case 404 belonging to LY(t) is smaller than the maximum value (9 points) of the service request level of the cases 405 to 407 belonging to LB(t). Thus, the conditional branch 503 gives NO. When the conditional branch 503 returns NO, the flow chart returns to the monitoring position 507. However, when the current time (t) moves to the right side from the position 410 to reach the position 411, the cases 404 to 406 belong to LY(t) and only the case 407 belongs to LB(t). At this time, the conditional branch 503 returns YES, and the flow chart moves to a process 505. In the process 505, the batch process is performed on all the cases belonging to LY(t). In other words, an unallocated salesperson with at least a slightly higher ability score is allocated to a case with at least a slightly higher service request level. When the allocation is performed, all the cases belonging to LY(t) move to the non-allocation period. The nearest neighbor allocation due time is also reset to a different value. For this reason, the set to which each case belongs varies, so that the elements of L0(t), L(t), LY(t), and LB(t) are redefined (process 506). Then, the flow chart returns to the monitoring position 507. This is the process flow in this embodiment.

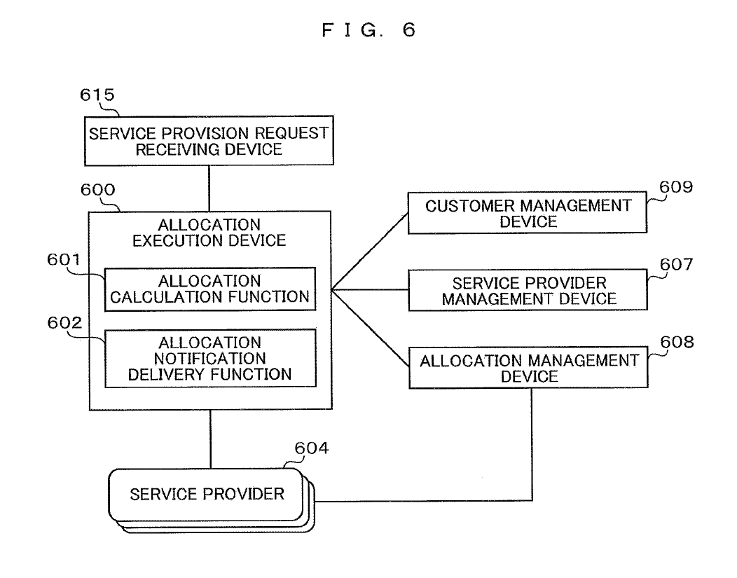

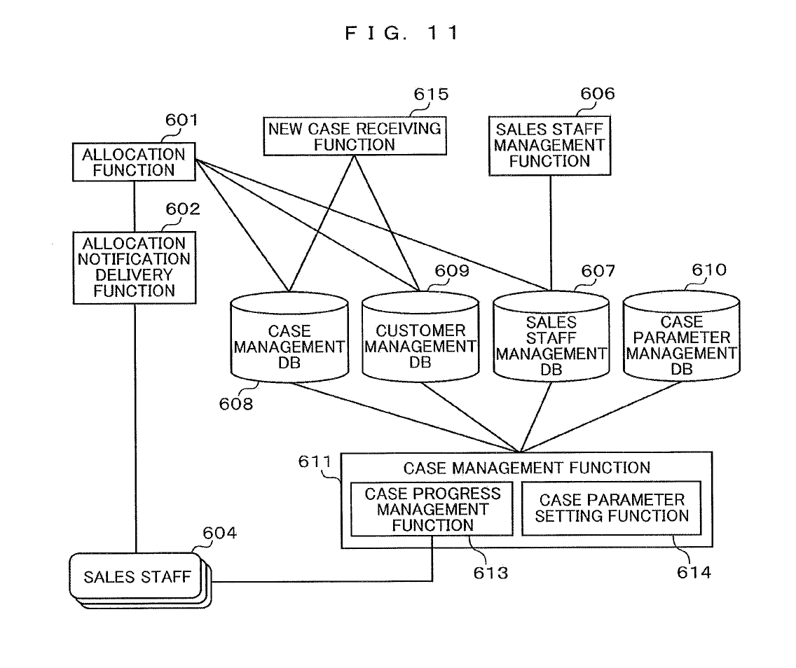

FIGS. 6 and 11 are configuration examples of the sales staff allocation system according to the present embodiment. In FIGS. 6 and 11, reference numeral 601 denotes an allocation calculation function that performs the process 504 or 505. Reference numeral 602 denotes an allocation notification delivery function that receives the allocation calculation result, which is the output of the allocation calculation function, from the allocation calculation function 601, to deliver an allocation message notification to each salesperson. Reference numeral 604 denotes a service provider represented by a service person. Reference numeral 607 denotes a service provider management device for managing the personal information of the salesperson. Reference numeral 608 denotes an allocation management device for managing the information of the current case. Reference numeral 609 denotes a customer management device for managing the personal information of the customer.

Note that when the process 504 or 505 is performed, the allocation calculation function 601 sorts the values of the “service request level” and the total ability scores (described below) of the unallocated sales staff, in descending order, to match each of the values from the largest value to the smallest value (namely, in the sorted order). The allocation calculation function 601 obtains the value of the “service request level” of the case from a case management table 701. In other words, the allocation calculation function 601 extracts the “sales staff ID” with the “status” unallocated in the service provider management table 900, and extracts the ability score (described below) of the particular “sales staff ID” from the service provider management table 900. Then, the allocation calculation function 601 extracts the “compatibility point” by substituting the information of the “customer ID” and the “sales staff ID” into a compatibility table 802. Then, the allocation calculation function 601 adds the ability score and the “compatibility point” to obtain the total score of the “sales staff ID”. Note that, for example, if the “case type” of the case is a medical insurance proposal, the ability score corresponds to the value of the “medical insurance knowledge level” of the service provider management table 900.

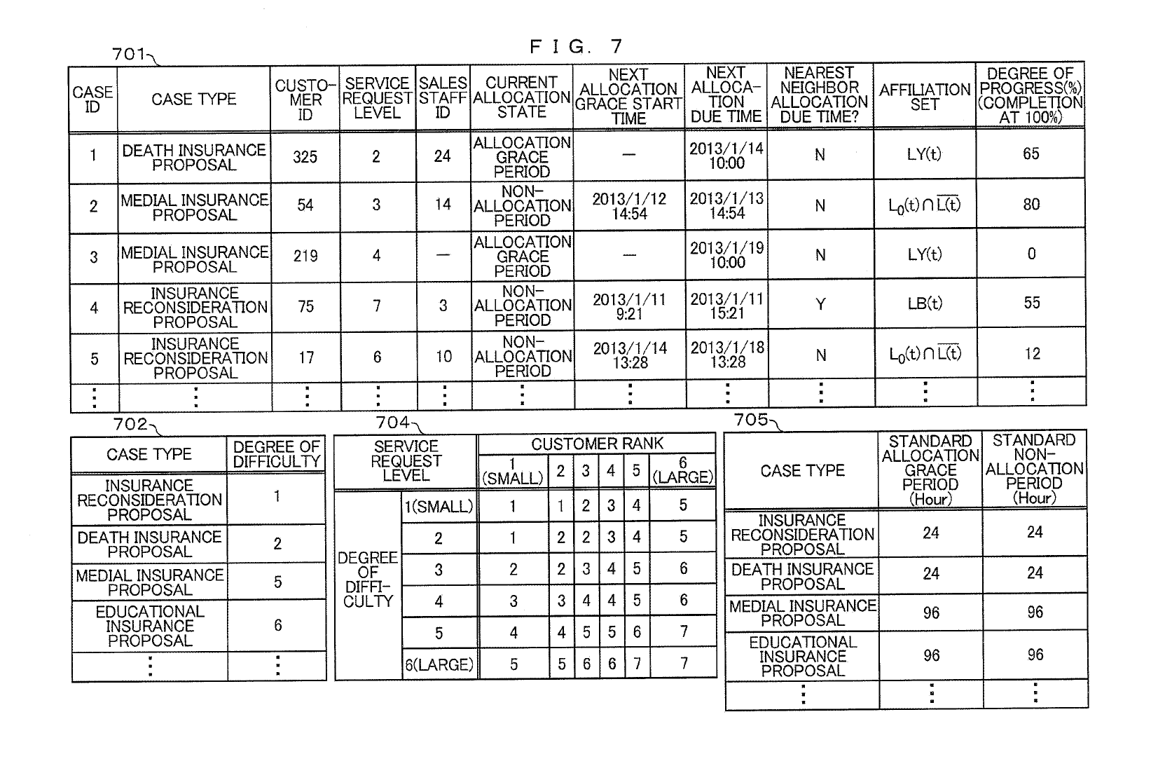

FIG. 7 shows all tables that the allocation management device 608 manages. The tables managed by the allocation management device 608 are the case management table 701, a difficulty definition table 702, a service request level definition table 704, and a period definition table 705. The difficulty definition table 702, the service request level definition table 704, and the period definition table 705 are referred to as case parameters. The case management table 701 can be configured in advance when the system administrator accesses the case management table management function 1014 (described below). The difficulty definition table 702, the service request level definition table 704, and the period definition table 705 can be configured in advance when the system administrator accesses a case parameter management function 1012 described below.

The case management table 701 includes the following data items. That is, “case ID” that identifies the case, “case type” that identifies the type of case such as insurance reconsideration proposal, death insurance proposal, medial insurance proposal, or educational insurance proposal, “customer ID” that identifies the customer, “service request level” that is converted into a number, “sales staff ID” that identifies the salesperson, “current allocation state” for determining whether each case is currently in the allocation grace period or in the non-allocation period, “next allocation grace start time”, “next allocation due time”, “nearest neighbor allocation due time?” for determining whether the case is the one to which the nearest neighbor allocation due time is given, “affiliation set” for giving a set to which each case belongs, and “degree of progress (%)” representing the progress in each case (0% for immediately after starting, 100% for completion). These data items are determined by the following mechanism. The “case ID” is set by a service provision request receiving device 615 with a number greater than the ID of the last case by one after receiving the case. The “case type” is set by the service provision request receiving device 615 with one of the case types in the period definition table 705, which is the closest to the case content.

The “customer ID” is set by the service provision request receiving device 615 with the “customer ID” corresponding to the “name” of the customer management table 800 by extracting the customer name from the case content. The “service request level” is set by the service provision request receiving device 615 with a value obtained by extracting the “case type” of the case management table 701, the “degree of difficulty” of the difficulty definition table 702, the “customer ID” of the case management table 701, and the “customer rank” of the customer management table 800, and by substituting the “degree of difficulty” and the “customer rank” into the service request level definition table 704. With respect to the “sales staff ID”, the allocation calculation function process 601 sets a combination of the “case ID” and the “sales staff ID”, which is the result of the batch allocation of the process 504 or 505, to the case management table 701. The “current allocation state”, the “next allocation grace start time”, the “next allocation due time”, the “nearest neighbor allocation due time”, the “affiliation set”, and the “degree of progress” are set by a case information editing function 1006, described below, with values.

The difficulty definition table 702 includes the following data items. That is, “case type” described in the case management table 701, and “degree of difficulty” showing the difficulty in completing each case type.

The service request level definition table 704 includes “degree of difficulty”, “customer rank”, and “service request level” that is determined by the two items. The meanings of the former two items are the same as the “degree of difficulty” of the difficulty definition table 702 and the “customer rank” of the customer management table 800.

The period definition table 705 includes the following data items. That is, “case type” described in the difficulty definition table 702, “standard allocation grace period” which is the parameter required for the determination of the allocation grace period shown in FIG. 3, and “standard allocation period” which is the parameter required for the determination of the non-allocation period shown in FIG. 3. The allocation grace period and the non-allocation period are determined as follows. When the service provision request receiving device 615 receives a new case, the values of the “standard allocation grace period” and the “standard non-allocation period” are respectively set to the values of the allocation grace period and the non-allocation period. In the case of reallocation (the second or subsequent allocation to the same case), the allocation grace period and the non-allocation period (for example, the allocation grace period 308) are determined by the following equations (Equation 1 and Equation 2).

Non-Allocation Period=Standard Non-Allocation Period*(1−Degree of Progress/100) (Equation 1)

Allocation Grace Period=Non-Allocation Period*(Standard Allocation Grace Period/Standard Non-Allocation Period) (Equation 2)

The “degree of progress” is the same as the “degree of progress” of the case management table 701. However, the above equations are examples for calculating the allocation grace period and the non-allocation period, and other formulas may be used.

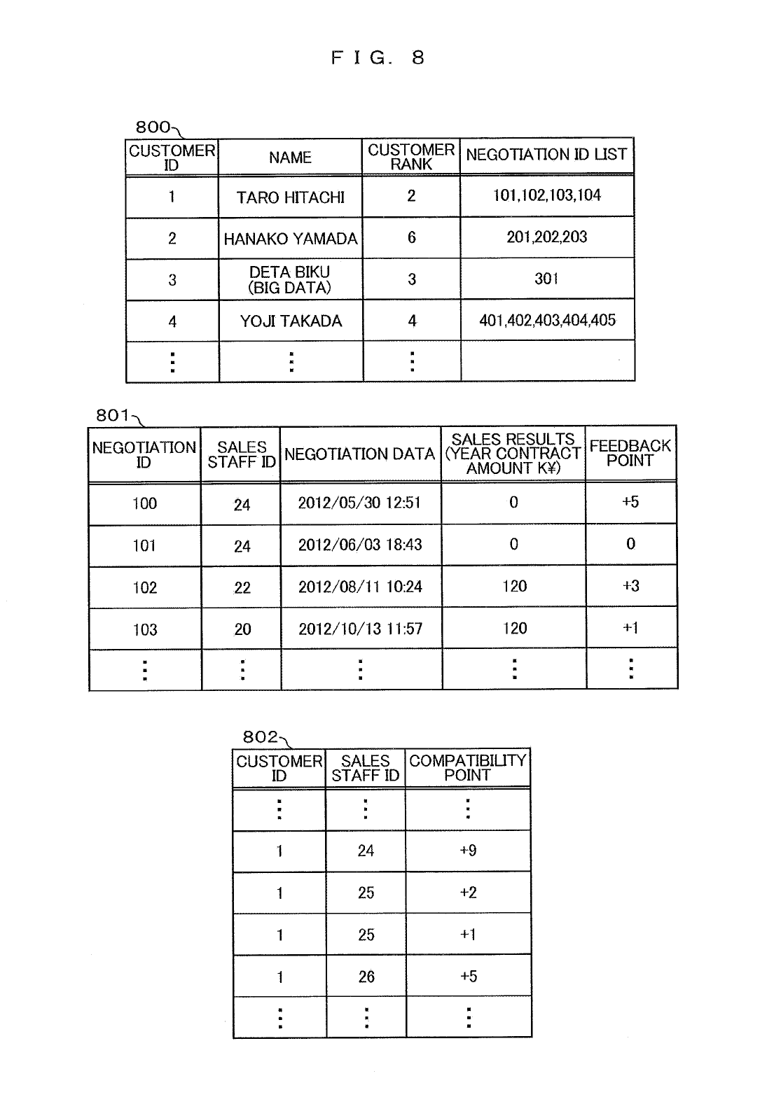

FIG. 8 shows all tables that the customer management device 609 manages. The tables managed by the customer management device 609 are a customer management table 800, a negotiation history table 801, and a compatibility table 802.

The customer management table 800 includes the following data items. That is, “customer ID” that identifies the customer, “name” indicating the name of the customer, “customer rank” indicating that the larger the number the more important the customer, and “negotiation ID” that identifies all the past sales activities (negotiation history) that have been performed by each salesperson to the same customer. The “customer ID” is set by the service provision request receiving device 615 with a new number when the customer name is not found in the customer management table 800. The value of the “customer rank” is set by either of the following two methods. The system administrator manually sets a value, or the customer management device automatically sets a value that is proportional to the sales contribution from the particular customer (which is calculated based on the “sales results” of the negotiation history table 801). The “negotiation ID” is set by the allocation calculation function 601 with a new value each time a salesperson is allocated to each case. Note that only the “name” is included in the customer management table 800 as the information indicating the customer attribute. However, other attributes such as address, telephone number, and age may be included in the table, or may be managed in another table.

The negotiation history table 801 includes the following data items. That is, “negotiation ID” described in the customer management table 800, “sales staff ID” that identifies the salesperson, “negotiation date” that indicates the date and time when the negotiation occurs, “sales results” that indicates the business outcomes (results) obtained through the particular negotiation, and “feedback point” which is the evaluation point of the salesperson. The determination method of the “negotiation ID” is the same as that described in the customer management table 800. The “sales staff ID” is set by the allocation calculation function 601 with the value of the “sales staff ID” of the case management table 701. The value of the “sales results” is set by the salesperson with the result value. The value of the “feedback point” is set by either of the following two methods. The particular salesperson inputs the evaluation results obtained from the customer (for example, asked to “continuously provide advice on other insurance products” by the customer, etc.), or the other salesperson inputs the results of the questionnaire conducted on the customer (the degree of customer satisfaction, etc.).

The compatibility table 802 includes the following data items. That is, “customer ID” described in the customer management table 800, “sales staff ID” described in the negotiation history table 801, and “compatibility point” that indicates the height of the compatibility between the customer and the salesperson. The “customer ID” is set by the service provision request receiving device 615 with the same value as the customer management table 800. The “sales staff ID” is set by the allocation calculation function 601 with the “sales staff ID” allocated to the case. As shown in the figure, when multiple salespersons have handled a particular customer in the past, multiple values of the “sales staff ID” correspond to the value of the same “customer ID”. The “compatibility point” is set by the customer management device 609 with a weighted sum of the total value of the “sales results” and the total value of the “feedback point” in the negotiation history table 801. In other words, the customer management device 609 extracts the “negotiation ID” list from the customer management table 800 with the value of the “customer ID” as the key, and extracts the values of the “sales results” and the “feedback point” from the negotiation history table 801 with the “negotiation ID” and the “sales staff ID” as the key. Then, the customer management device 609 counts the “sales results” and the “feedback point” with respect to one pair of the “customer ID” and the “sales staff ID”. Note that the weighted value is set by the system administrator to the customer management device 609 in advance.

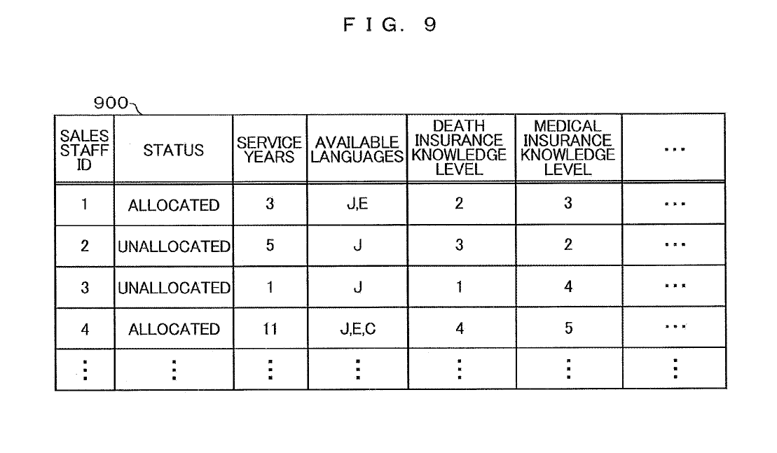

FIG. 9 is the service provider management table 900 managed by the service provider management device 607.

The service provider management table 900 includes the following data items. That is, “sales staff ID” that identifies the salesperson, “status” indicating whether the particular salesperson has been allocated to a certain case, “service years” indicating the number of years the salesperson has worked, “available languages” which is the list of languages the salesperson can speak, “death insurance knowledge level” indicating how much the salesperson knows about death insurance products, “medical insurance knowledge level” indicating how much the salesperson knows about medial insurance products, and other multiple parameter items indicating the ability score of each salesperson. The “sales staff ID” is set by the system administrator with a new number each time a new salesperson joins the company. The “status” is set by the allocation execution device 600 with a value “allocated” after the allocation is performed, and set by the allocation management device 608 with a value “unallocated” immediately after the completion of the case. With respect to the “service years”, the service provider management device 607 automatically updates the value from the employment continuously. The “death insurance knowledge level”, the “medial insurance knowledge level”, and the parameter group indicating the knowledge level of the other insurance products are set and updated by the system administrator based on the result such as an internal test.

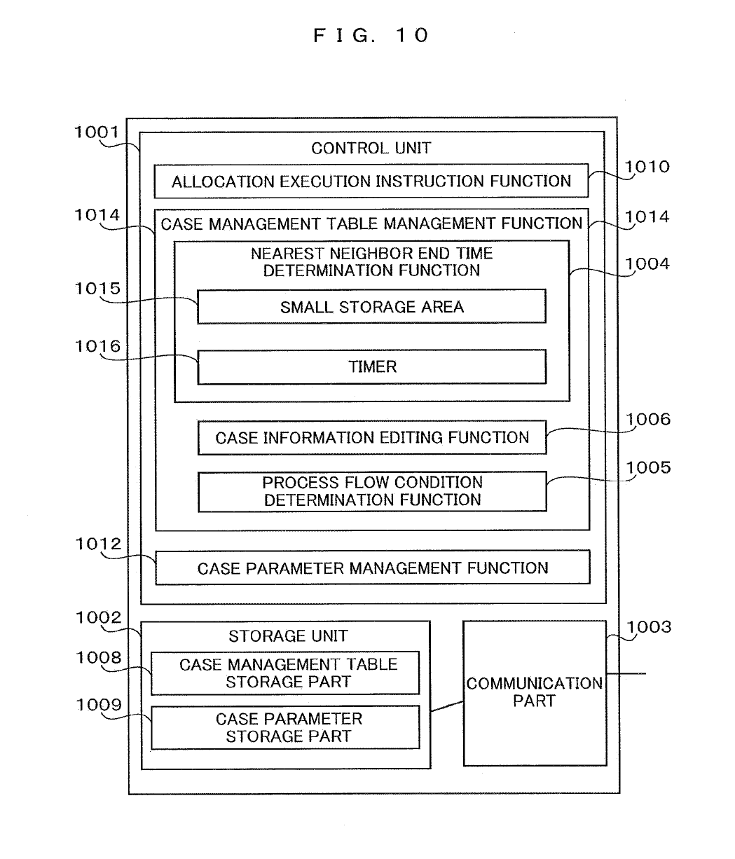

FIG. 10 is the hardware configuration within the allocation management device 608. In the figure, reference numeral 1001 denotes the control unit such as a CPU, reference numeral 1002 denotes the storage unit such as RAM, and reference numeral 1003 denotes the communication part 1003 such as an interface.

The control unit 1001 includes the following functions. That is, an allocation execution instruction function 1010 that instructs the allocation calculation function 601 to start allocation execution calculation, a case management table management function 1014 for managing the case management table 701 stored in a case management table storage part 1008, and a case parameter management function 1012 for managing the case parameters stored in a case parameter storage part 1009.

The storage unit 1002 includes the following functions. That is, the case management table storage part 1008 for storing the case management table 701, and the case parameter storage part 1009 for storing the case parameters.

The case management table management function 1014 includes the following functions. That is, as described below, a nearest neighbor end time determination function 1004 for determining whether the nearest neighbor end time matches the current time, a case information editing function 1006 for editing all data items of the case management table 701, and a process flow condition determination function 1005 for determining the conditional branch 503 and the conditional branch 504.

The details of each function will be described below. Note that each function is realized by a program, which is read by each device realized as a computer, and according to which information processing is performed.

The nearest neighbor end time determination function 1004 includes a small storage area 1015 for storing the nearest neighbor end time, and a timer 1016 for storing and updating the current time in real-time. The nearest neighbor end time shows the time closest to the current time, of the end time of the allocation grace period in the case present in the phase thereof and the end time of the non-allocation period in the case present in the phase thereof, with respect to all cases. The nearest neighbor end time determination function 1004 obtains the current time from the timer 1016, and the nearest neighbor end time from the small storage area 1015. Then, the nearest neighbor end time determination function 1004 determines whether the two values match in the control unit 1001 sequentially in real-time. The nearest neighbor end time determination function 1004 does not perform if the two values do not match. When the two values match, the nearest neighbor end time determination function 1004 activates the case information editing function 1006.

The case information editing function 1006 is the function that accesses the case management table storage part 1008 to edit all data items of the case management table 701. Further, this function has a GUI function for the service provider 604 to edit the case management table 701. The case information editing function 1006 updates the information of all the cases, when receiving a new case from the service provision request receiving function 615 (case addition), or receiving a case completion notification from the service provider 604 (case deletion), or receiving a start notification from the nearest neighbor end time determination function 1004 (arrival the nearest neighbor end time determination time), or when the service provider 604 edits a part of the case management table 701. Then, the case information editing function 1006 passes all information of the cases belonging to L(t) of the case management table 701 to the process flow condition determination function 1005. After that, the case information editing function 1006 updates the value of the nearest neighbor end time of the small storage area 1015.

The process flow condition determination function 1005 is the function that determines the conditional branch 502 and the conditional branch 103 shown in FIG. 5. The process flow condition determination function 1005 obtains the information of the cases belonging to L(t) from the case information editing function 1006, and performs the conditional branch 502. If the determination result of the conditional branch 502 is NO, the flow chart moves to the conditional branch 503. If the determination result of the conditional branch 502 is YES, the process flow condition determination function 1005 delivers the information of the cases belonging to L(t) to the allocation calculation function 601. As a result of performing the conditional branch 503, if the determination result is NO, nothing is done. If the determination result of the conditional branch 503 is YES, the process flow condition determination function 1005 delivers the information of the cases belonging to LY(t), which is the subset of L(t), to the allocation calculation function 601.

The case parameter management function 1012 is the function that accesses the case parameter storage part 1009 to edit the difficulty definition table 702, or the service request level definition table 704, or the period definition table 705. Further this function has a GUI function for the service provider 604 to edit these tables.

What is claimed is:

1. A service provider allocation system for allocating one of a plurality of service providers engaging a given organization to a user, the service provider allocation system comprising:
a section that receives a service provision request to the user as a case;
a section that calculates a grace period for extending an allocation process with respect to the received case; and
a section that controls the allocation to cases including the target case, according to the state relating to allocation of the other cases while reflecting the compatibility between the other service providers and the user in the particular grace period.

2. The service provider allocation system according to claim 1,
wherein the section that controls the allocation includes:
placing the allocation of the target case in a suspending state, when a case with a hither service request level than the target case continues in the grace period;
performing the allocation process, including the target case, when detecting a case with a higher service request level than the target case in the grace period; and
performing the allocation process when one of the cases reaches an allocation due time.

3. The service provider allocation system according to claim 1,
wherein the section that controls the allocation allocates a plurality of service providers to the cases, as a whole, as a batch process.

4. The service provider allocation system according to claim 3, further comprising:
a section that updates the allocation to the case;
a section that determines a set of cases to be allocated when the allocation is updated; and
a section that notifies the section that controls the allocation of the particular set of cases.

5. The service provider allocation system according to claim 4, further comprising a control unit for storing the update time and the current time,
wherein the control unit sequentially determines whether the update time matches the current time.

6. A servicer provider allocation method for allocating one of a plurality of service providers engaging a given organization to a user, by using an information processing device, the service provider allocation method comprising:
receiving a service provision request to the user as a case;
calculating a grace period for extending an allocation process with respect to the received case; and
controlling the allocation to cases including the target case, according to the state relating to allocation of the other cases while reflecting the service request level including the compatibility between the other service providers and the user in the particular grace period.

7. The service provider allocation method according to claim 6,
wherein the process for controlling the allocation includes:
placing the allocation of the target case in a suspending state, when a case with a higher service request level than the target case continues in the grace period;
performing the allocation process, including the target case, when detecting that a case with a higher service request level than the target case does not continue in the grace period; and
performing the allocation process when any of the cases reaches the allocation due time.

8. The service provider allocation method according to claim 6,
wherein the process for controlling the allocation allocates a plurality of service providers to the cases, as a whole, as batch allocation.

9. The service provider allocation method according to claim 8, further comprising:
updating the allocation to the case;
determining a set of cases to be allocated when the allocation is updated; and
notifying the section that controls the allocation of the particular set of cases.

10. The service provider allocation method according to claim 9,
wherein the information processing device includes a control unit for storing the update time and the current time, and
wherein the control unit sequentially determines whether the update time matches the current time.
